(19) United States
(12) Patent Application Publication
(10) Pub. No.: US 2019/0124728 A1
(43) Pub. Date: Apr. 25, 2019

(54) Code Arrangement and Package of System for Cooking a Foodstuff

(71) Applicant: Nestec S.A., Vevey (CH)

(72) Inventors: Alexandre PERENTES, Sullens (CH); Praveen Kumar VADI, Aurora, OH (US)

(21) Appl. No.: 16/092,139

(22) PCT Filed: May 22, 2017
(86) PCT No.: PCT/EP2017/062203

§ 371 Date: Oct. 8, 2018

(30) Foreign Application Priority Data
May 24, 2016 (EP) 16171089.2

(51) Int. Cl. H05B 6/64; B65D 81/34; G06K 19/06

(52) U.S. Cl. CPC H05B 6/6441; G06K 19/0615; B65D 81/3446; B65D 81/343

(57) ABSTRACT

The invention relates to a package (10) of a foodstuff cooking device, the package (10) for containing foodstuff and comprising on a surface thereof an arrangement of separate codes encoding foodstuff information related to phases of a preparation process for cooking the foodstuff, at least one code encoding information on at least one foodstuff parameter significantly influencing the preparation of the foodstuff, which considers the deviation of the real value of this at least one parameter with respect to a reference value of it. The at least one parameter measured is one or a combination of the following: weight of the foodstuff; weight of one or several ingredients in the foodstuff; geometrical distribution of one or several ingredients in the foodstuff; foodstuff initial temperature; foodstuff age; foodstuff uniformity; proportion and/or shape dimension of one or several ingredients in the foodstuff.

The invention further relates to a foodstuff cooking system (100) comprising a package (10) as the one described and a cooking device (20). Furthermore, the invention also relates to a method of cooking a foodstuff using the system (100) described.

### FIELD OF THE INVENTION

The present invention relates to a system for cooking a foodstuff, the system comprising a cooking device and a package comprising a foodstuff material. More particularly the invention relates to a code arranged on the package that encodes foodstuff information related to the preparation information of the said foodstuff and to a method of cooking the foodstuff.

### BACKGROUND OF THE INVENTION

Increasingly cooking devices (such as ovens or microwaves) for the cooking of a foodstuff are configured to operate with a package or some kind of container comprising a foodstuff in its inner volume: at present, in order to enhance user convenience compared to conventional cooking devices, these packages are provided with a code either comprising certain cooking parameters or a certain encoding referring to a cooking recipe stored in the device in order to apply an appropriate cooking process to the foodstuff.

It is known in the state of the art, for example from document EP 1971189, a cooking oven, particularly a microwave oven, detecting food data and adjusting the food heating and/or the cooking process by means of a user interface. However, this system works with pre-stored recipes to be applied to the foodstuff, which makes that the process is not always optimal, and it also requires interaction from the user.

Document EP 1742513 discloses, for example, a cooking apparatus, cooking system and cooking control method using a bar code. The cooking apparatus for cooking food using cooking data includes a memory for storing identification data and cooking data of the food; an image capture device for obtaining an image of the food; and a controller for identifying the food by comparing the image of the food to the identification data of the food, stored in the memory, obtaining the cooking data of the identified food, and controlling the cooking apparatus so that the cooking of the food is performed based on the cooking data. This system therefore uses pre-stored data on recipes on how to process the foodstuff in the cooking apparatus, which is not always optimal.

Another example is provided by document EP 1732358, disclosing an apparatus and a method for controlling a microwave oven using a bar code. The apparatus includes an operating panel on the microwave oven, a bar code scanner in the operating panel and projecting light to the bar code attached to a package of food to obtain data of the bar code, and a main controller for controlling a cooking operation for cooking the food according to the data of the bar code obtained by the bar code scanner. The apparatus performs the cooking of food using the bar code, according to certain recipes stored. However, as already disclosed, cooking is not always optimally done.

When cooking is intended to be done in a very optimal way, it should therefore be needed that the code in the package or container provides a certain number of parameters comprising cooking information on the cooking process to be applied. This would require to encode large amounts of information as preparation processes increase in complexity due to the development of more sophisticated machines, which are able to prepare a wide-range of foodstuff.

However, even when a large number of data and cooking information is comprised in the code, the meals produced in the same device vary depending on the starting parameters of the foodstuff comprised in the package or container. For example, when it comes to frozen meals, the final meals cooked in a same device or oven under the same cooking parameters are not the same, as the departing data of the frozen foodstuff varies, typically for example a weight variation has been detected when a foodstuff is produced industrially. When looking even closer, there is even a variation on all the different ingredients in a meal or foodstuff in a package or container. For example, when several trials have been run on the same departing product, even when applying the same cooking or process parameters, results vary in a high extent. Moreover, the variation range is so large that it becomes significant for the consumer, appreciating that the final product has not been optimally processed by the system.

Therefore, there exists the need of providing a code arrangement on a container or package of foodstuff, this code further comprising information on one or several departing parameters, such as for example weight, in order to properly adjust the cooking parameters applied and optimise the cooking process.

### SUMMARY OF THE INVENTION

According to a first aspect, the invention relates to a package of a foodstuff cooking device, the package for containing foodstuff and comprising on a surface thereof an arrangement of separate codes encoding foodstuff information related to phases of a preparation process for cooking the foodstuff, at least one code encoding information on at least one foodstuff parameter significantly influencing the preparation of the foodstuff, which considers the deviation of the real value of this at least one parameter with respect to a reference value of it.

Typically, the at least one parameter measured in the package according to the invention is one or a combination of the following: weight of the foodstuff; weight of one or several ingredients in the foodstuff; geometrical distribution of one or several ingredients in the foodstuff; foodstuff initial temperature; foodstuff age; foodstuff uniformity; proportion and/or shape dimension of one or several ingredients in the foodstuff.

The codes preferably further comprise foodstuff information, such as brand and/or foodstuff group and/or foodstuff type, this foodstuff information being used to stablish the reference value of the at least one parameter significantly influencing the preparation of the foodstuff.

Typically, according to the invention, the arrangement of separate codes further comprises a dynamic code providing information on at least one parameter varying in time. The dynamic code preferably provides information of the instant foodstuff temperature, the dynamic code typically using thermochromic ink.

In the package of the invention, the passage from distinct phases in the preparation process for cooking the foodstuff is preferably triggered by the phase duration and/or by the instant foodstuff temperature and/or by the foodstuff moisture content and/or by the foodstuff colour and/or by the foodstuff absorption at specific wavelengths.

Typically, the codes in the package of the invention are arranged as a plurality of columns, the columns being adjacent each other and extending along parallel tracks, whereby adjacent columns are offset with respect to each other in a direction along said tracks.

Typically, the code comprises a reference portion and a data portion: the reference portion comprising a linear arrangement of at least two reference units defining a reference line r, the data portion comprising at least one data unit, wherein said data unit is arranged on an encoding line D that intersects the reference line r, the data unit occupies a distance d along the encoding line D as a variable to at least partially encode a parameter significantly influencing the preparation of the foodstuff.

Typically, the encoding line D in the package of the invention has one of the following arrangements:

the encoding line D is circular and is arranged with a tangent thereto orthogonal to the reference line rat said intersection point;

the encoding line D is linear and arranged orthogonal to the reference line r.

According to one embodiment, the said arrangement of codes in the package of the invention are formed on a surface of the package or on an attachment, which is attached thereto.

According to a second aspect, the invention further relates to a foodstuff cooking system comprising a package as the one described and a cooking device, comprising: a code processing system operable to: obtain one or more digital image(s) of a plurality of codes of the package; process said digital image(s) to decode for each parameter the encoded foodstuff information; a control system operable to control the cooking device according to a preparation process comprising one or a plurality of phases in a determined order, the cooking process being stablished according to the foodstuff parameters information.

Preferably, in the foodstuff cooking system of the invention, the cooking process is stablished by the control system referring to a stored library of cooking recipes. Another option according to the invention is that the cooking process is stablished by the control system being connected to a remote server in order to access updated foodstuff processing information.

In the foodstuff cooking system according to the invention, the code processing system can be arranged either in the cooking device and/or in the system and/or it can be externally arranged.

Still according to a third aspect, the invention further relates to a method of cooking a foodstuff using the system as the one described, the method comprising: obtaining one or more digital images of a plurality of codes of the container; processing said digital image(s) to decode the foodstuff information; accessing data to determine processing phases and their order; a control system operable to control the preparation unit to execute the preparation process using said processing phases and their order.

### BRIEF DESCRIPTION OF THE DRAWINGS

For a better understanding of the invention, and to show how embodiments of the same may be carried into effect, reference will now be made, by way of example, to the accompanying diagrammatic drawings in which:

FIGS. 1-2 are illustrative views of an embodiment of a cooking system according to the invention comprising a cooking device and a package containing foodstuff.

FIG. 3 is block diagram of a control system for the cooking device of FIG. 1 or 2.

FIGS. 4A-B show embodiment code arrangements for packages for the cooking system of FIGS. 1-2.

FIGS. 5-8E show embodiment codes for packages for the cooking system of FIGS. 1-2.

FIG. 9 shows one possible embodiment of a cooking system according to the invention, as shown in FIGS. 1-2, where the code processing system is arranged in the cooking device.

FIG. 10 shows another possible embodiment of a cooking system according to the invention, as shown in FIGS. 1-2, where the code processing system is arranged outside the cooking device.

### DETAILED DESCRIPTION OF EXEMPLARY EMBODIMENTS

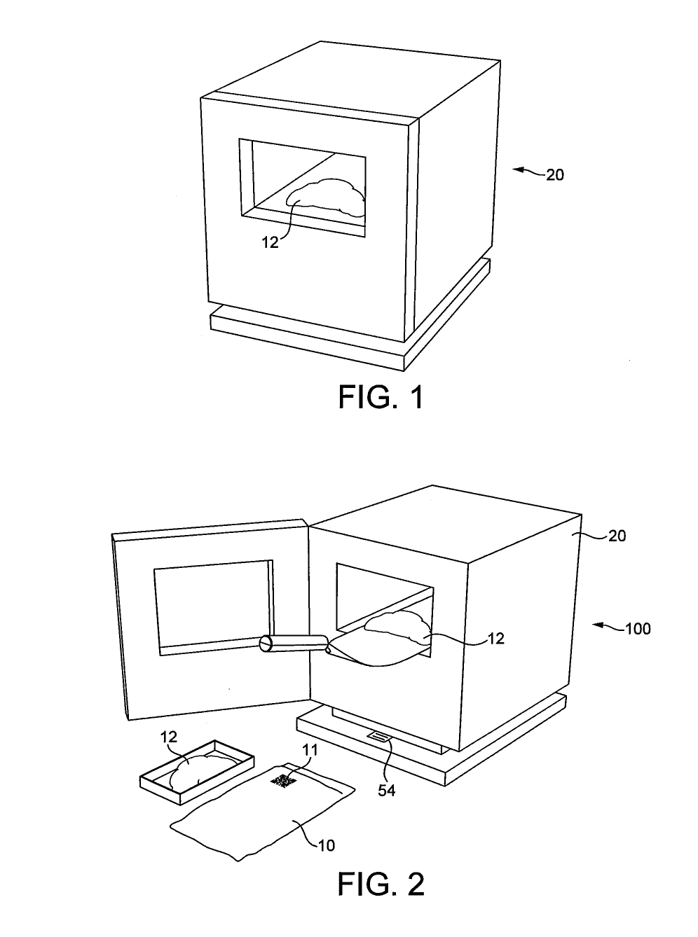

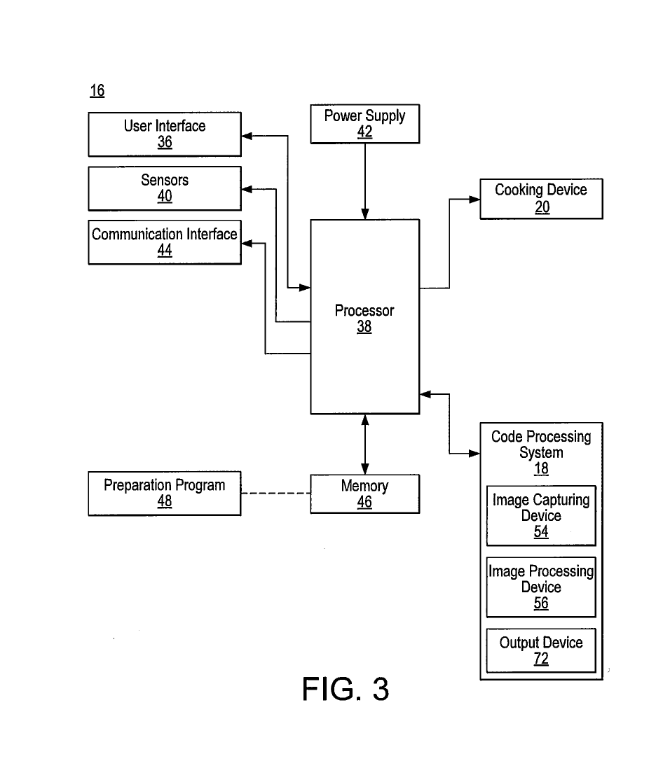

The invention presents a cooking system 100 for cooking a foodstuff as exemplified in FIG. 1 or 2: the cooking system 100 comprises a cooking device 20 and a package 10, the package comprising a foodstuff material in its inner volume. The package 10 comprises identification means 11 (typically a code) with foodstuff information related to phases of a preparation process for cooking the foodstuff. The encoded information comprises data on at least one foodstuff parameter influencing the preparation of the foodstuff, which considers the deviation of the real value of this at least one parameter with respect to a reference value of it.

Typically, the cooking device 20 is an oven or a microwave oven which is able to process the foodstuff content of the package 10. In many cases, the foodstuff in the package 10 is a frozen product, which is taken out from the package before it is processed in the device 20: the device then applies a cooking procedure depending on the product to be cooked and further on certain parameters as it will be further explained.

When the product is being manufactured, there are certain parameters which can deviate from standard production, such as for example the actual weight of the product, or the actual weight of the ingredients in it. When a standard cooking process is applied to this product, final results will deviate from expected, and the product will not be optimal. Therefore, the codification in the identification means 11 of the product needs to take into consideration the real parameters in production. In the production line, at least one parameter (for example, the weight of the product and/or of its ingredients) is measured and it is indicated or printed in the identification means 11. According to the invention, at least one foodstuff parameter influencing the preparation or cooking of the foodstuff is comprised in the identification means 11, this at least one parameter considering the deviation of its real value with respect to a reference value of it. Typically, the at least one parameter measured in the invention is one or a combination of the following: weight of the foodstuff; weight of one or several ingredients in the foodstuff; geometrical distribution of one or several ingredients in the foodstuff; foodstuff initial temperature; foodstuff age; foodstuff uniformity; proportion and/or shape dimension of one or several ingredients in the foodstuff. As it will be further explained in more detail, the device 20 will then apply a certain cooking process optimal for the real foodstuff being cooked so the consumer will be ensured with same guaranteed quality at the end, i.e. the optimal process is stablished taking into consideration the real value of at least one foodstuff parameter influencing the foodstuff preparation process.

In the package 10 described, the codes further comprise foodstuff information, such as brand and/or foodstuff group and/or foodstuff type. This foodstuff information is used to stablish the reference value of the at least one parameter significantly influencing the preparation of the foodstuff.

When it comes to using the system of the invention with foodstuff originally frozen when introduced in the device, the identification means can further be provided with at least one dynamic parameter, such as the departing temperature of the product when being introduced in the device. For this, the identification means 11 will be further provided with encoded information made using for example temperature sensitive ink varying depending on real temperature dynamically measured with time, which therefore indicates the device the real temperature of the foodstuff at the moment in time when the product is being cooked. For example, several dots are made with temperature sensitive ink: some of them start disappearing when the temperature raises for example, so the remaining dots indicate the device the real temperature of the foodstuff to cook, so cooking parameters are consequently adapted.

Preferably, in the package 10 of the invention, the passage from distinct phases in the preparation process for cooking the foodstuff is triggered by the phase duration and/or by the instant foodstuff temperature and/or by the foodstuff moisture content and/or by the foodstuff colour and/or by the foodstuff absorption at specific wavelengths

The cooking system according to the invention further comprises a control system 16 and a code processing system 18, similar to those described in patent application EP 15165920.8, belonging to the same applicant and incorporated by reference, herewith.

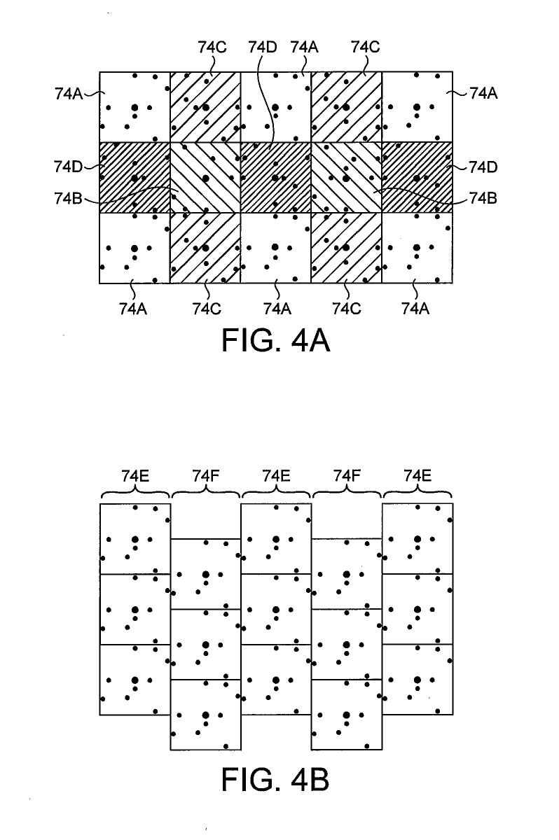

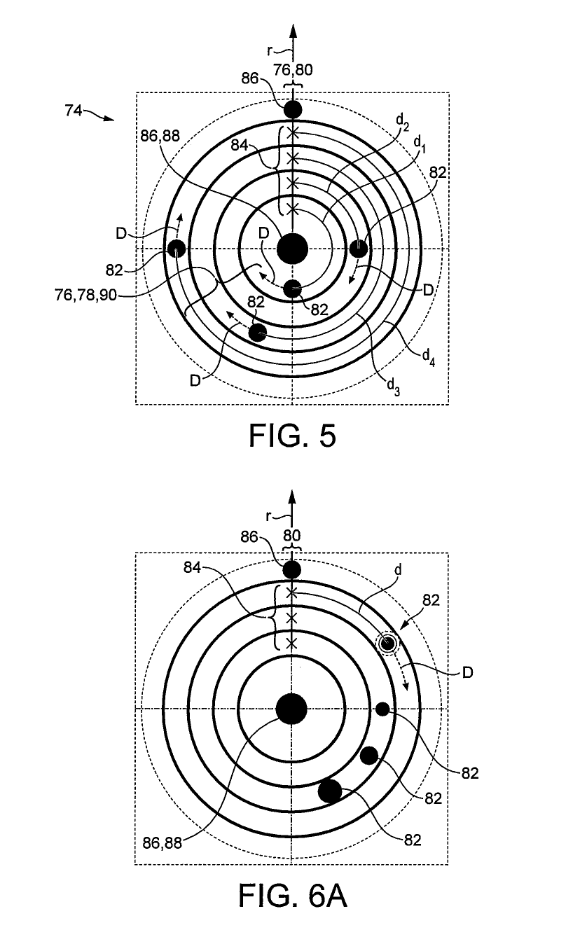

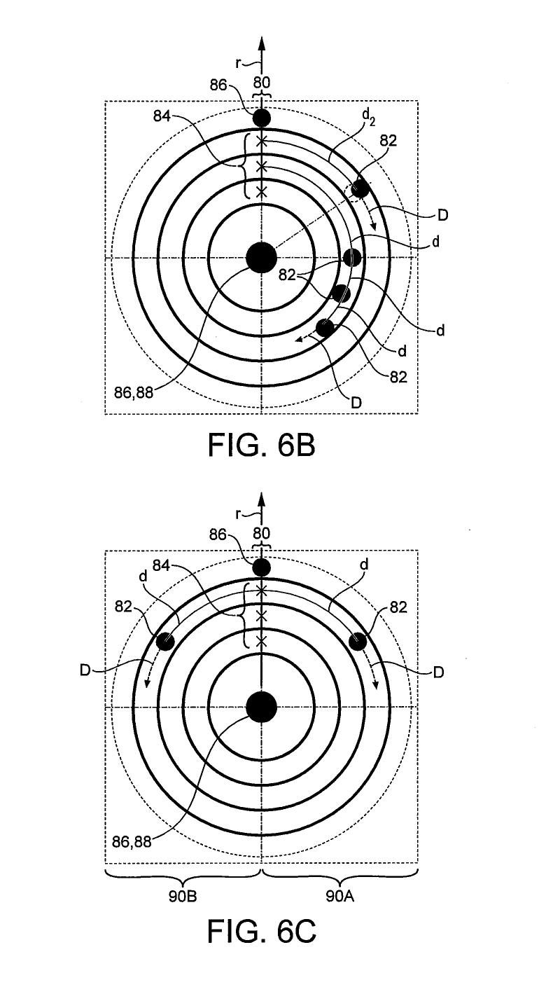

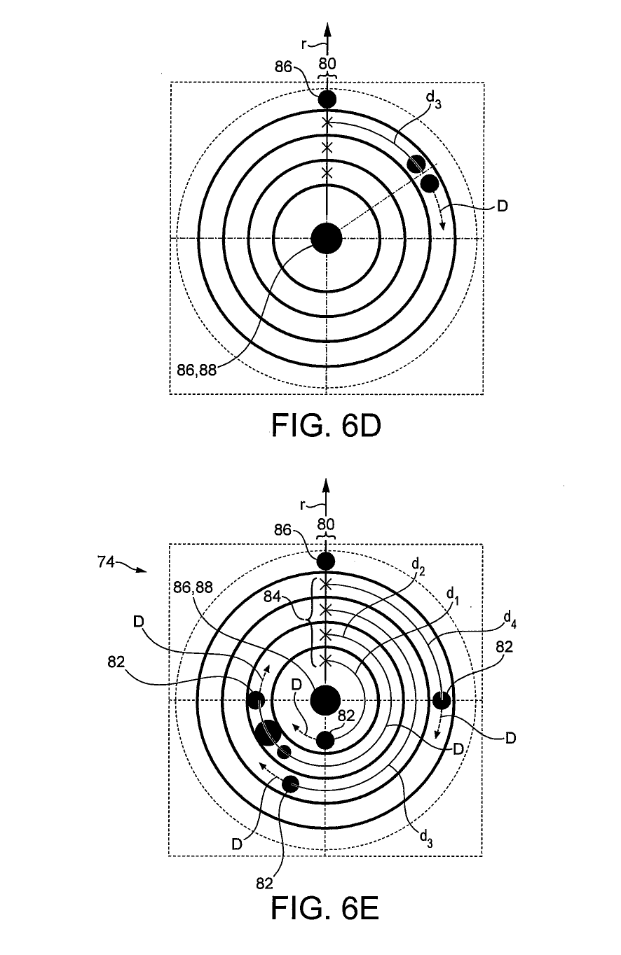

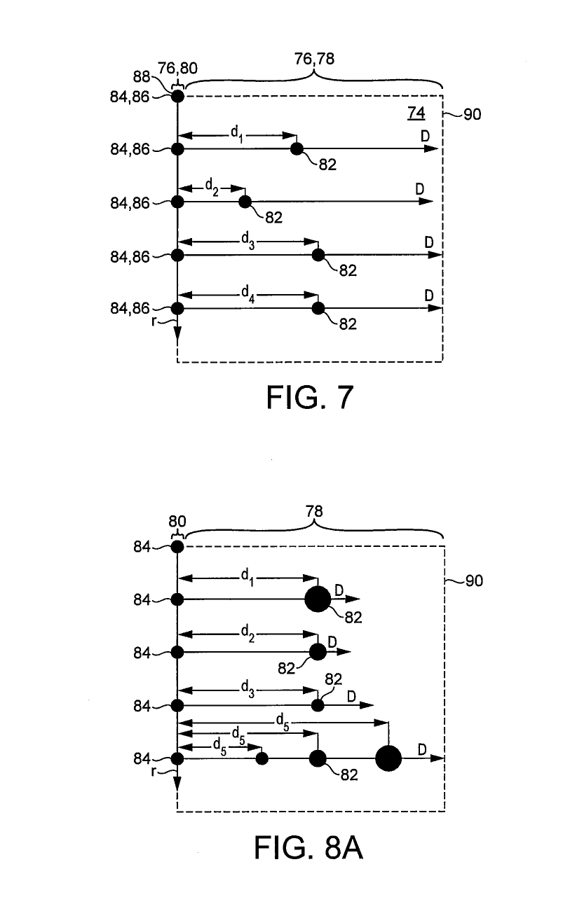

The control system 16, an example of which is illustrated in FIG. 3, is operable to control the cooking device 20 to prepare the foodstuff. The control system 16 typically comprises: a user interface 36; a processor 38; optional sensors 40; a power supply 42; an optional communication interface 44; all of these having been described in EP 15165920.8.

Typically, the package 10 comprises an external package and inside a foodstuff which can optionally be frozen. The package 10 may be formed from various materials, such as metal or plastic or a combination thereof. In general, the material is selected such that it is food-safe and can withstand the cooking temperatures. As discussed, the identification means 11 are preferably arranged in the external package and are read by the code processing system 18, which obtains an image of the code on the package 10 and processes said image to decode the encoded foodstuff information from which the preparation information of said foodstuff can be accessed. As shown in FIG. 3, the code processing system 18 comprises an image capturing device 54, an image processing device 56 and an output device 72.

The distinct phases in the preparation process for cooking the foodstuff may for example comprise values of one or a plurality of the following parameters:
type of cooking or heating means used (microwave, infrared, hot air, etc.)
time of application of each of the cooking or heating means used
frequency of microwave heating means
temperature of hot air heating means
power of infrared heating means
positioning or geometrical application of each of the heating means used
cooling means used
time of application of cooling means
temperature of cooling air used
temperature of the product at the end of the process
phase identifier, e.g. an alphanumeric identifier, to identify which of a plurality of phases the aforesaid one or more parameters relate etc.

As already mentioned, it has to be taken into consideration that the codes, system and method described in EP 15165920.8 is incorporated herewith by reference, also different embodiments of said code therein described.

According to another aspect, the invention further relates to a method of cooking a foodstuff using the system 100 previously described. The method according to the invention comprises:
obtaining one or more digital images of a plurality of codes of the container 10;
processing said digital image(s) to decode the foodstuff information;
accessing data to determine processing phases and their order;
a control system operable to control the preparation unit to execute the preparation process using said processing phases and their order.

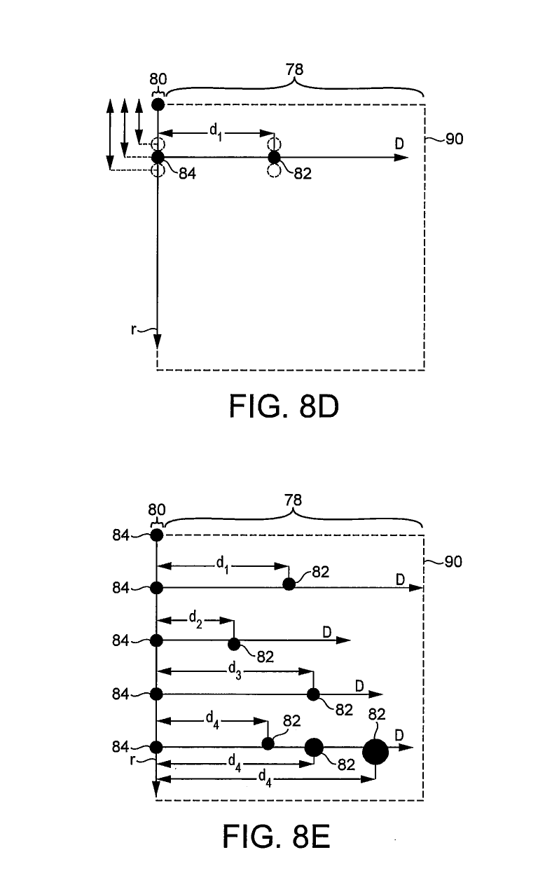

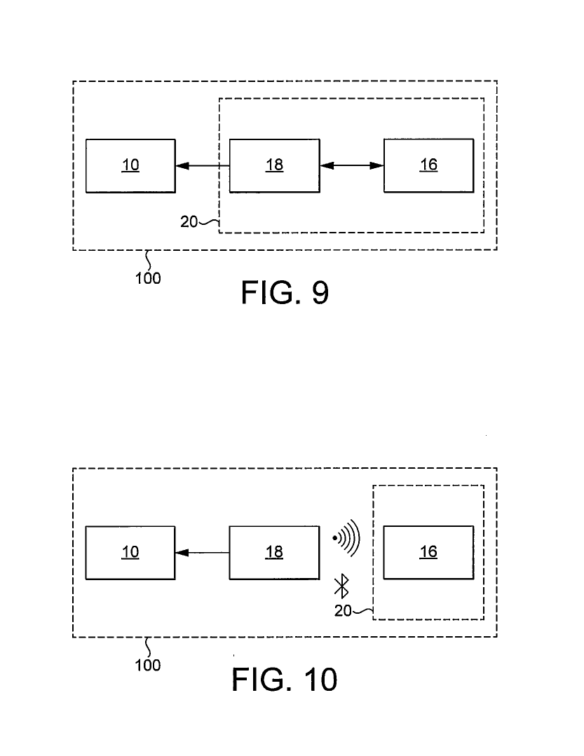

According to the invention, the foodstuff cooking system 100 typically comprises a container 10 as the one described and a cooking device 20. The system 100 comprises a code processing system 18 and a control system 16: as shown in FIGS. 9 and 10, there are two possible embodiments: the devoice 20 can comprise both the processing system 18 and the control system 16 or it can only comprise the control system 16, the processing system 18 being in the system 100. In any of the two embodiments, the code processing system 18 is operable to obtain one or more digital image(s) of a plurality of codes of the package 10 and process said digital image(s) to decode for each parameter the encoded foodstuff information. The control system 16 is then operable to control the cooking device 20 according to a preparation process comprising one or a plurality of phases in a determined order, the cooking process being stablished according to the foodstuff parameters information.

The cooking process can be stablished by the control system 16 referring to a stored library of cooking recipes or it can be stablished by the control system 16 being connected to a remote server in order to access updated foodstuff processing information.

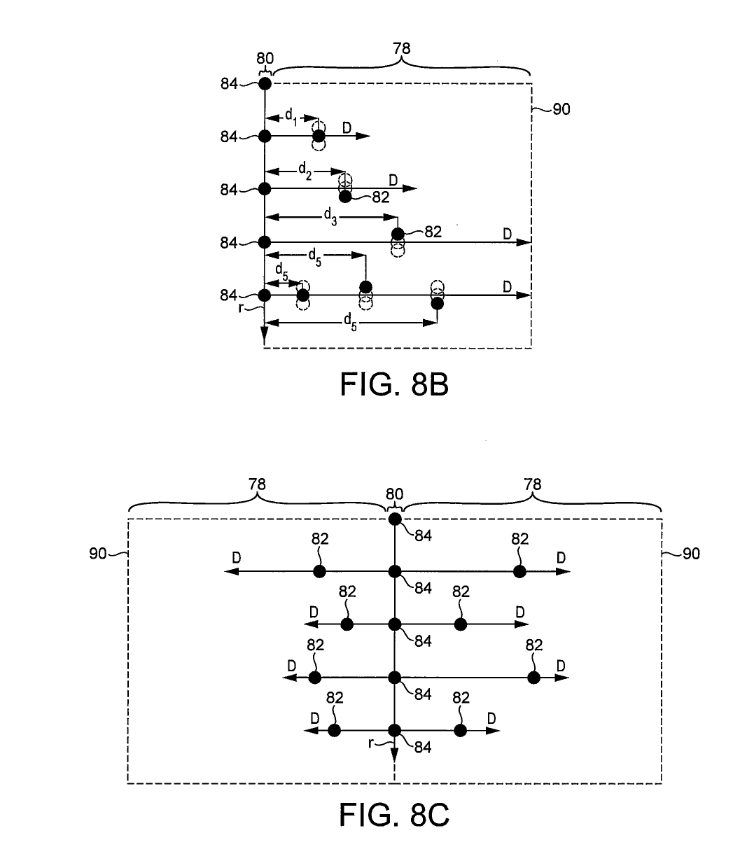

The code processing system 18 can be arranged in the cooking device 20 (FIG. 8) and/or in the system 100 (FIG. 9) and/or be externally arranged (not shown). FIG. 8 shows the case where both the processing system 18 and the control system 16 are arranged in the cooking device 20, so the communication is made within the device 20. FIG. 9 shows the case where only the processing system i18 is in the device 20 and therefore the communication with the control system 16 is made by Bluetooth or Wi Fi or similar.

Although the present invention has been described with reference to preferred embodiments thereof, many modifications and alternations may be made by a person having ordinary skill in the art without departing from the scope of this invention which is defined by the appended claims.

Listing of claims:

1. A package of a foodstuff cooking device, the package for containing foodstuff and comprising on a surface thereof an arrangement of separate codes encoding foodstuff information related to phases of a preparation process for cooking the foodstuff, at least one code encoding information on at least one foodstuff parameter significantly influencing the preparation of the foodstuff, which considers the deviation of the real value of this at least one parameter with respect to a reference value of it.

2. The package according to claim 1, wherein the at least one parameter measured is one or a combination of the following: weight of the foodstuff; weight of one or several ingredients in the foodstuff; geometrical distribution of one or several ingredients in the foodstuff; foodstuff initial temperature; foodstuff age; foodstuff uniformity; proportion and/or shape dimension of one or several ingredients in the foodstuff.

3. The package according to claim 1, wherein the codes further comprise foodstuff information.

4. The package according to claim 3, wherein the foodstuff information is used to stablish the reference value of the at least one parameter significantly influencing the preparation of the foodstuff.

5. The package according to claim 1, wherein the arrangement of separate codes further comprises a dynamic code providing information on at least one parameter varying in time.

6. The package according to claim 5, wherein the dynamic code provides information of the instant foodstuff temperature.

7. The package according to claim 5, wherein the dynamic code uses thermochromic ink.

8. The package according to claim 1, wherein the passage from distinct phases in the preparation process for cooking the foodstuff is triggered by the phase duration and/or by the instant foodstuff temperature and/or by the foodstuff moisture content and/or by the foodstuff colour and/or by the foodstuff absorption at specific wavelengths.

9. The package according to claim 1, wherein the codes are arranged as a plurality of columns, the columns being adjacent each other and extending along parallel tracks, whereby adjacent columns are offset with respect to each other in a direction along said tracks.

10. The package according to claim 1, wherein the code comprises:
a reference portion comprising a linear arrangement of at least two reference units defining a reference line r;
a data portion comprising at least one data unit, wherein said data unit is arranged on an encoding line D that intersects the reference line r, the data unit occupies a distance d along the encoding line D as a variable to at least partially encode a parameter significantly influencing the preparation of the foodstuff.

11. The package according to claim 1, wherein the encoding line D has one of the following arrangements:
the encoding line D is circular and is arranged with a tangent thereto orthogonal to the reference line r at said intersection point; or
the encoding line D is linear and arranged orthogonal to the reference line r.

12. The package according to claim 1, wherein the arrangement of codes are formed on a surface of the package or on an attachment, which is attached thereto.

13. A foodstuff cooking system comprising:
a package according to claim 1; and
a cooking device, comprising:
a code processing system operable to: obtain one or more digital image(s) of a plurality of codes of the package; process said digital image(s) to decode for each parameter the encoded foodstuff information;
a control system operable to control the cooking device according to a preparation process comprising one or a plurality of phases in a determined order, the cooking process being established according to the foodstuff parameters information.

14. The foodstuff cooking system according to claim 13, wherein the cooking process is established by the control system referring to a stored library of cooking recipes.

15. The foodstuff cooking system according to claim 13, wherein the cooking process is established by the control system being connected to a remote server in order to access updated foodstuff processing information.

16. The foodstuff cooking system according to claim 13, wherein the code processing system is arranged in the cooking device and/or in the system and/or is externally arranged.

17. A method of cooking a foodstuff using the system according to claim 16, the method comprising:
obtaining one or more digital images of a plurality of codes of the container;
processing said digital image(s) to decode the foodstuff information;
accessing data to determine processing phases and their order;
a control system operable to control the preparation unit to execute the preparation process using said processing phases and their order.
